(19) United States
(12) Patent Application Publication
(10) Pub. No.: US 2003/0205682 A1
(43) Pub. Date: Nov. 6, 2003

(54) Evaluation of multicomponent mixtures using modulated light beams

(76) Inventors: Rakesh Kapoor, Amherst, NY (US); Martin Casstevens, Amherst, NY (US)

Correspondence Address: HODGSON RUSS LLP, ONE M & T PLAZA, SUITE 2000, BUFFALO, NY, 14203-2391, US

(21) Appl. No.: 10/429,426

(22) Filed: May 5, 2003

Related U.S. Application Data
(60) Provisional application No. 60/377,935, filed on May 3, 2002.

(51) Int. Cl. G01J 1/58

(52) U.S. Cl. 250/458.1

(57) ABSTRACT

A method of analyzing sample material having more than one fluorescing species comprises the steps of providing a plurality of intensity-modulated excitation light beams each being modulated at a respective unique frequency; directing the intensity-modulated excitation light beams to interact with the sample material; detecting fluorescence emission light from the sample material to provide signal information representative of detected light intensity versus time; and extracting a plurality of component emission signals from the signal information, wherein each component emission signal corresponds to a respective one of the modulated excitation light beams. Apparatus for implementing the method include flow cytometers and bulk sample analytical optical systems. The invention is helpful in determining species concentrations in cases where the fluorescing species have overlapping or substantially the same emission spectra.

### CROSS-REFERENCES TO RELATED APPLICATIONS

This application claims the benefit of U.S. Provisional Application No. 60/377,935 filed May 3, 2002.

### STATEMENT REGARDING FEDERALLY SPONSORED RESEARCH

The U.S. government has a paid-up license in this invention and the right in limited circumstances to require the patent owner to license others on reasonable terms as provided for by the terms of Contract No. DE-FG02-01ER83134 awarded by the Department of Energy.

### FIELD OF THE INVENTION

The invention relates to a method and apparatus for analyzing a sample material in which two or more fluorescent dyes are present.

### BACKGROUND OF THE INVENTION

Fluorescence spectroscopy is now a fundamental analytical tool in the physical, chemical, and biological sciences. Analysis of a sample material commonly involves the use of more than one fluorophore. For example, in the biological sciences, it is common to label cells with more than one fluorochrome to facilitate the study of cellular properties. Modulated light sources are regularly employed with lock-in detection techniques to attain better signal to noise measurements. However, it is often difficult to find suitable fluorescent dyes that share common excitation spectra but have separate emission spectra, whereby a single excitation source can be used and the emission spectra can be detected by detecting different wavelength regions of the emitted fluorescence light.

Several approaches to overcoming this limitation have been described. In one flow cytometer approach described by Steinkamp et al., different wavelengths of excitation light are used to sequentially excite fluorescent dyes having separated excitation spectra, and the emitted fluorescence light is detected using a multichannel detector arrangement for sequentially detecting different wavelength regions. See J. Steinkamp et al., Improved Multilaser/Multiparameter Flow Cytometer for Analysis and Sorting of Cells and Particles, Rev. Sci. Instrum., Vol. 62 (11), pages 2751-2764 (November, 1991). In another approach, fluorescent dyes having overlapping emission spectra can be utilized by employing an intensity-modulated excitation beam in cooperation with phase-resolution techniques to discriminate between emissions having different fluorescence lifetimes. See the following references: D. Jameson et al., The Measurement and Analysis of Heterogeneous Emissions by Multifrequency Phase and Modulation Fluoremtry, Applied Spectroscopy Rev. Vol. 20 (1), pages 55-106 (1984); L. McGown et al., Phase-Resolved Fluorescence Spectroscopy, Analytical Chemistry, Vol. 56 No. 13 (November, 1984); J. Steinkamp, U.S. Pat. No. 5,270,548 issued Dec. 14, 1993 for Phase-Sensitive Flow Cytometer; and J. Keij et al., Simultaneous Analysis of Relative DNA and Glutathione Content in Viable Cells by Phase-Resolved Flow Cytometry, Cytometry, Vol. 35, pages 48-54 (1999).

While these approaches have broadened analytical possibilities, the first approach adds cost and complexity to instrumentation hardware, and the second approach requires that the chosen dyes have significantly different fluorescence lifetimes.

### SUMMARY OF THE INVENTION

The present invention involves a method and apparatus for analyzing sample materials containing more than one fluorescing species. The invention is embodied in an apparatus generally comprising means for providing a plurality of intensity-modulated excitation light beams for interaction with the sample material, each beam being modulated at a respective unique frequency; a photosensitive detector receiving fluorescence light emitted by the sample material in response to interaction with the excitation light beams and providing signal information representative of the intensity of received light; and means connected to the detector for receiving and processing the signal information to extract a plurality of component signals respectively attributed to the plurality of excitation light beams. The distinctive modulation frequencies of the excitation beams are present in the fluorescence light emitted by the sample material and received by the detector. Consequently, the detector signal information can be processed to extract component signals corresponding to each excitation frequency, for example by Fourier transform analysis of the detector signal information. Because each excitation beam has a unique frequency, the fluorescence signal contribution attributable to each excitation beam can be determined. Assuming knowledge of the excitation spectra and fluorescence quantum yields at different wavelengths of each fluorescent dye present, information about the concentrations of each fluorescing species can be derived.

The present invention is embodied, for example, in a flow cytometer having a pair of laser light sources that are intensity-modulated at different frequencies, a flow cell through which a fluid sample material passes and interacts with the modulated excitation beams, a filter which receives both scattered excitation light and emitted fluorescence light from the sample material and blocks the excitation light wavelengths, a photomultiplier tube behind the filter for receiving the fluorescence light and generating intensity signal information, and a digital storage oscilloscope for processing the signal information to determine the signal contribution attributed to each modulated excitation beam. Other embodiments are disclosed, including systems for analyzing bulk sample material in a sample well and a fiber optic system.

The method of the present invention generally comprises the steps of providing a plurality of intensity-modulated excitation light beams each being modulated at a respective unique frequency; directing the intensity-modulated excitation light beams to interact with the sample material; detecting fluorescence emission light from the sample material to provide signal information representative of detected light intensity versus time; and extracting a plurality of component emission signals from the signal information, wherein each component emission signal corresponds to a respective one of the modulated excitation light beams. The strengths of the component emission signals can then be evaluated in view of known dye properties to determine the concentrations of the fluorescing species in the sample material.

### BRIEF DESCRIPTION OF THE DRAWINGS

The nature and mode of operation of the present invention will now be more fully described in the following detailed description of the invention taken with the accompanying drawing figures, in which:

FIG. 1 is a plot showing excitation and emission spectra of a pair of fluorescing species in a mixture, wherein the wavelengths of first and second excitation light beams are also indicated;

FIG. 2 is a schematic diagram of a flow cytometer formed in accordance with a first embodiment of the present invention for analyzing a sample material having more than one fluorescing species;

FIG. 3 is a schematic diagram of a flow cytometer formed in accordance with a second embodiment of the present invention for analyzing a sample material having more than one fluorescing species;

FIG. 4 is a schematic diagram of a system formed in accordance with a third embodiment of the present; invention for analyzing a bulk sample material having more than one fluorescing species;

FIG. 5 is a schematic diagram of a system formed in accordance with a fourth embodiment of the present invention for analyzing a bulk sample material having more than one fluorescing species;

FIG. 6 is a schematic view showing, in relevant part, a system for analyzing bulk samples contained in an well plate having an array of sample wells;

FIG. 7 is a schematic diagram of fiber optic system formed in accordance with a fifth embodiment of the present invention for analyzing a sample material having more than one fluorescing species;

FIG. 8 is a schematic diagram showing an alternative means for generating a plurality of modulated excitation light beams in accordance with the present invention; and

FIG. 9 is a schematic diagram showing another alternative means for generating a plurality of modulated excitation light beams in accordance with the present invention.

### DETAILED DESCRIPTION OF THE INVENTION

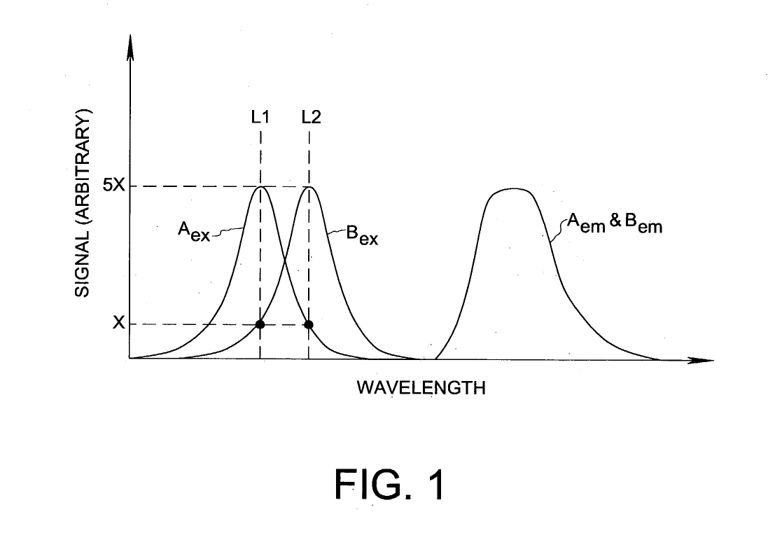

Referring initially to FIG. 1 of the drawings, a plot showing excitation and emission spectra of a pair of hypothetical fluorescent dyes A and B is presented in order to illustrate one situation in which the present invention proves useful. As can be seen, dyes A and B have overlapping excitation spectra and the same emission spectra. A pair of laser excitation light beams at different wavelengths are indicated by dotted lines L1 and L2. From a broad standpoint, the present invention involves intensity modulation of L1 and L2 at different frequencies so that their respective contributions can be extracted from the detected fluorescence signal.

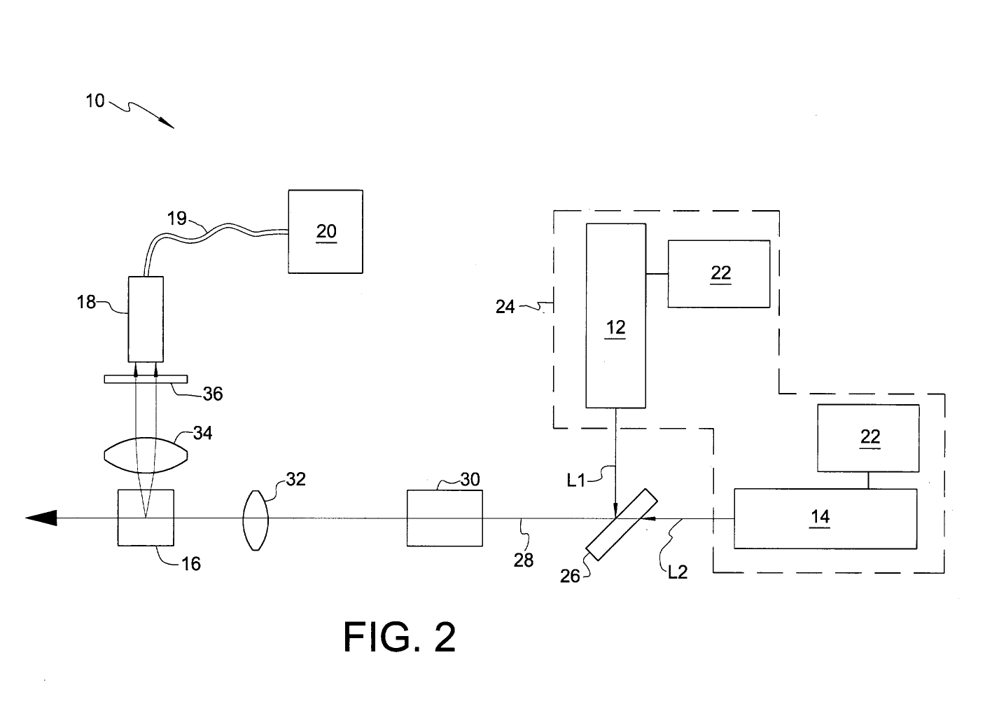

Attention is now directed to FIG. 2, which schematically depicts a flow cytometer 10 formed in accordance with a first embodiment of the present invention. Flow cytometer 10 generally comprises first and second light sources 12 and 14, a flow cell 16 through which a sample material flows, a photosensitive detector 18 arranged to receive fluorescence light emitted from the sample material, and a digital storage oscilloscope 20 connected to detector 18 by communication line 19. In the embodiment shown, light sources 12 and 14 are semiconductor lasers each emitting light at 635 nanometers, however the light sources 12 and 14 can also be chosen to emit light at different wavelengths as shown for example in FIG. 1. Light sources 12 and 14 are each energized by current from a respective drive circuit 22. The drive current supplied to each light source 12, 14 is modulated in known fashion according to a periodic waveform (preferably sinusoidal), with each light source receiving current modulated at a different frequency and not harmonics of one another. Consequently, light emitted by light sources 12 and 14 is modulated at a respectively unique frequency corresponding to the associated drive current modulation frequency. As can be seen in FIG. 2, light sources 12 and 14 together with associated current drive circuits 22 serve as a means 24 for providing a pair of intensity-modulated excitation light beams L1 and L2 for interaction with the sample material flowing through an interrogation zone of flow cell 16. As used herein, the term “light beam” is intended to have a broad meaning, and includes without limitation convergent, divergent, and collimated beams; electromagnetic flux by fiber optic transmission; and any flow of electromagnetic waves.

Excitation light from beam L1 is reflected by a beam combining optical element 26 for travel along optical path 28, whereas excitation light from beam L2 is transmitted by optical element 26 for travel along the same optical path 28. Beam combining optical element may be, for example, a polarizing cube beamsplitter where L1 and L2 have s and p polarizations. The differently modulated excitation light L1 and L2 is stretched along one axis by a cylindrical lens telescope system 30 and then focused on an interrogation zone in flow cell 16 by a focusing lens 32.

A collector lens or lens system 34 is arranged adjacent to flow cell 16 along a path that is orthogonal to incident beam path 28 for collimating scattered excitation light and emitted fluorescence light coming from the sample material. A filter 36 is provided after collector lens 34 and in front of detector 18 to remove scattered excitation light at 635 nm.

In the present embodiment, detector 18 is a photomultiplier tube (PMT), for example a Perkin Elmer CPM C962-2. Detector 18 generates signal information representative of the intensity of received light, which signal information is transmitted over line 19 to digital storage oscilloscope 20. The signal information from detector 18 is in the form of an aggregate emission signal wherein signal amplitude changes with time. The intensity modulation frequencies in L1 and L2 are chosen so that the modulation frequencies are reproduced in the fluorescence light emitted by the sample material. The signal information is processed by digital storage oscilloscope 20 to extract two component emission signals respectively corresponding to intensity modulated beams L1 and L2. More specifically, digital storage oscilloscope 20 collects the signal data into a file which can be later analyzed using a Fast Fourier Transform (FFT) algorithm to find the contribution of each modulation frequency to the aggregate fluorescence emission signal generated by detector 18.

The extracted component emission signals can be evaluated to derive the concentrations of the fluorescing species in the sample material. In the case of one dye , the strength of the collected signal for any one laser is a function of: 1) light intensity (laser power, focusing arrangement, optical losses); 2) probability of light absorption (absorption coefficient); 3) likelihood of a fluorescence emission (fluorescence quantum yield); 4) other factors affecting the measured intensity of fluorescence emission such as reabsorption of fluorescence light by the sample, quenching (especially as a function of increased concentration), and environmental factors such as complex formation; 5) probability that a fluorescence photon will reach the detector (efficiency of light collection system); 6) response of the detector at the fluorescence wavelength; and 7) signal electronics. It is a challenge to precisely relate signal intensity to concentration from consideration of the above parameters alone. However, one can calibrate the method and equipment using standards having the same dyes at known concentrations.

In the absence of any kind of self absorption the, fluorescence signal S_{f} is related to the excitation intensity I with the following relation.

S_{f}=KIη(1−e^{σNl}) (1)

where K is a constant of the collection and detection system, η is the quantum efficiency, σ is the absorption cross-section, N is the concentration of the fluorescent dye and l is the length of the interaction volume. If the value of product σNl is very small, the above equation can be rewritten as

S_{f}KINlησ (2).

If there are two types of fluorescent dye and two excitation lasers the signal due to both the lasers will be given as

S₁=KII₁(N_{A}η_{A}σ_{A1}+N_{B}η_{B}σ_{B1}) (3)

S₂=KII₂(N_{A}η_{A}σ_{A2}+N_{B}η_{B}σ_{B2}) (4)

where subscripts A and B refer to the two fluorescent dyes and the subscripts 1 and 2 refer to the two excitation beams respectively. Here it is assumed that the interaction length l for both the excitation beams is the same. It is clear from equation (3) and (4) that information about the concentration of two fluorescent dyes can easily be obtained from the two fluorescence signals (S₁& S₂) if the system parameter K, excitation intensities (I₁, & I₂) and the fluorophore parameters (η_{A}, η_{B} & σ_{A1}, σ_{A2}, σ_{B1}, σ_{B2}) are known.

To further illustrate how this technique can be employed the following table based on the hypothetical system of FIG. 1 is provided to illustrate how the extracted component emission signals can be evaluated to provide an indication of relative concentrations of fluorescing species A and B in a sample material.

| | 2 | 3 | 4 | 5 | 6 | 7 | 8 | 9 | 10 |
|---|---|---|---|---|---|---|---|---|---|
| 1 | Conc. | Conc. | Signal | Signal | Signal | Siganl | Total | Total | Ratio |
| Mixture | A | B | L1-A | L1-B | L2-A | L2-B | L1 | L2 | L1/L2 |
| #1 | 0 | 1 | 0*5 | 1*1 | 0*1 | 1*5 | 1 | 5 | 0.2 |
| #2 | 0.1 | 1 | 0.1*5 | 1*1 | 0.1*1 | 1*5 | 1.5 | 5.1 | 0.3 |
| #3 | 0.25 | 0.75 | 0.25*5 | 0.75*1 | 0.25*1 | 0.75*5 | 2 | 4 | 0.5 |
| #4 | 0.5 | 0.5 | 0.5*5 | 0.5*1 | 0.5*1 | 0.5*5 | 3 | 3 | 1.0 |
| #5 | 0.75 | 0.25 | 0.75*5 | 0.25*1 | 0.75*1 | 0.25*5 | 4 | 2 | 2.0 |
| #6 | 1 | 0.1 | 1*5 | 0.1*1 | 1*1 | 0.1*5 | 5.1 | 1.5 | 3.4 |
| #7 | 1 | 0 | 1*5 | 0*1 | 1*1 | 0*5 | 5 | 1 | 5.0 |
| #8 | 1 | 1 | 1*5 | 1*1 | 1*1 | 1*5 | 6 | 6 | 1.0 |

In this hypothetical system it is assumed that the absorption (molar extinction ratios), fluorescence quantum efficiencies, and fluorescence lifetimes of dyes A and B are equivalent. We have also assumed that fluorescence is not reabsorbed, and there are no quenching or other environmental factors altering the dyes' properties. The concentration of dyes is low enough that the attenuation of excitation intensity is negligible. Also for purposes of simplicity, it is assumed that that the intensities of L1 and L2 are the same, their wavelengths are as shown, and their modulation frequencies are not harmonics of one another. Consequently, excitation beam L1 excites dye A five times more than it excites dye B, while excitation beam L2 excites dye B five times more than it excites dye A. The detector receives a fraction of the fluorescence light that is generated from both sample dyes. The time varying signal from the detector has two components: a component at the frequency corresponding to modulated excitation beam L1 and a component at the frequency corresponding to modulated excitation beam L2.

In the above table, column 1 assigns a case number to specific concentrations of dye A (column 2) and dye B (column 3). Columns 4-7 calculate the contribution to the total signal for each dye-laser combination. These values are the product of the concentration and a measure of the amount of absorbed light at the laser wavelength. Column 8 is the sum of columns 4 and 5 and column 9 is the sum of columns 6 and 7. The values of columns 8 and 9 are equivalent to the two frequency components of the aggregate or total detector signal and can be experimentally determined. As mentioned above, these component signal values can be derived by Fourier transform analysis of the signal information from detector 18. The ratio of column 8 to column 9 is entered in column 10

The table illustrates several important points. First, samples containing either A alone or B alone have widely different characteristic ratios (column 10), namely 5.0 for A alone (Mixture #7) in contrast to 0.2 for B alone (Mixture #1). Thus, if a cell or bead marked by species A alone or species B alone passes through the interrogation zone of flow cytometer 10, the particle's identity can be readily ascertained by the ratio. This development is already an important accomplishment of the present invention and permits particles marked by dyes having overlapping spectral properties to be mixed together and be readily distinguished from one another. Second, it will be observed that the mixtures of species A and B also give rather distinct ratio values. When the absolute amounts of A and B are different, but the ratio of their concentrations is the same (Mixtures #4 and #8), the characteristic ratio L1/L2 is the same, but not the values in columns 8 and 9 which are directly proportional to dye concentrations.

In the embodiment described above, the detector 18 is free to detect the entire bandwidth of the fluorescence emission light from the sample material, except for the spectral region of scattered light blocked by filter 36. The capabilities of the basic system can be improved dramatically by adding further light sources providing excitation light at different wavelengths along with further detectors to detect different wavelength regions. In this manner, a large number of light sources and detectors can be used to obtain even greater amounts of information. The option of spatially separating different laser beams is envisioned in order to improve performance.

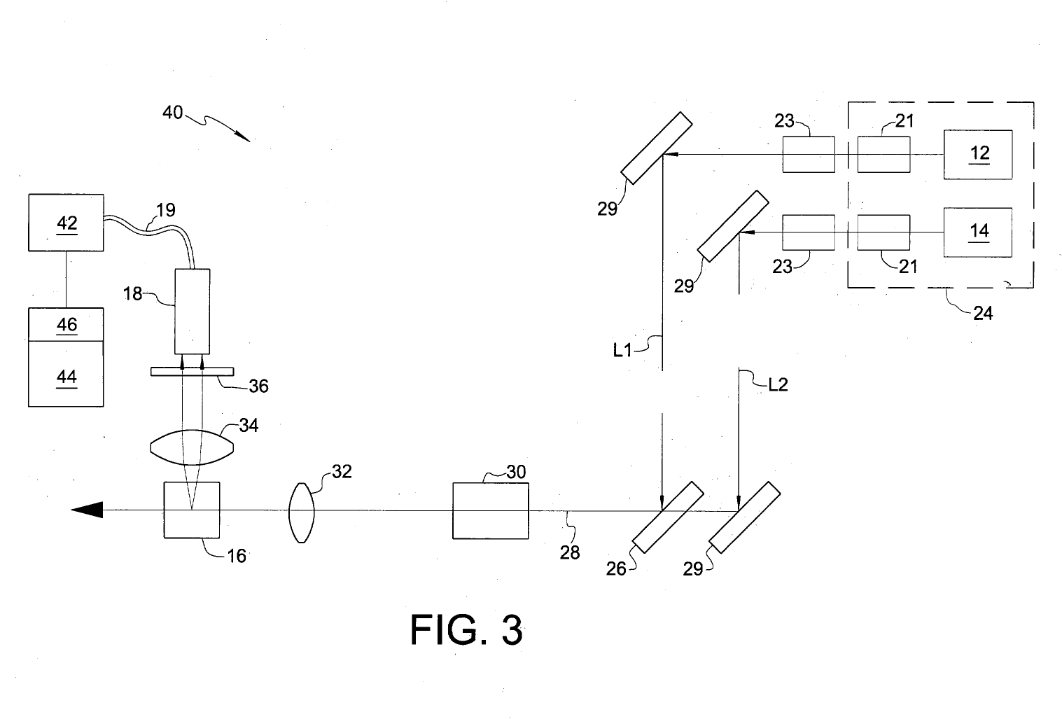

FIG. 3 shows a flow cytometer 40 formed in accordance with a second embodiment of the present invention. Flow cytometer 40 generally comprises first and second light sources 12 and 14, a flow cell 16 through which a sample material flows, a photosensitive detector 18 arranged to receive fluorescence light emitted from the sample material, signal electronics 42 connected to detector 18 by communication line 19, and a computer 44 having an internal analog-to-digital conversion card 46. In the embodiment shown, light sources 12 and 14 are continuous wave lasers each emitting excitation light at different frequencies from one another. The excitation light beams from light sources 12 and 14 are each modulated by a respective beam modulator 21 acting on the associated excitation light beam. Each modulator 21 functions to modulate the intensity of the excitation light beam coming from an associated light source 12 or 14 according to a periodic waveform, such that the excitation light beams are modulated at respectively unique frequencies corresponding to the setting of the associated modulator 21. Thus, light sources 12 and 14 together with associated beam modulators 21 function as a means 24 for providing a pair of intensity-modulated excitation light beams L1 and L2 for interaction with the sample material flowing through an interrogation zone of flow cell 16.

Modulated excitation light beam L1 passes through a telescope system 23 and is reflected by a mirror 29 in the direction of beam combining optical element 26. Likewise, modulated excitation light beam L2 passes through a telescope system 23 and is reflected by a pair of mirrors 29 such that beam combing optical element 26 will transmit light from beam L2 and reflect light from beam L1 along a common optical path 28. The differently modulated excitation light L1 and L2 is stretched along a single axis by cylindrical lens telescope system 30 and then focused on an interrogation zone in flow cell 16 by focusing lens 32.

As in the first embodiment described above, a collector lens 34 is arranged adjacent flow cell 16 along a path that is orthogonal to incident beam path 28 for collimating scattered excitation light and emitted fluorescence light coming from the sample material. A filter 36 is provided after collector lens 34 and in front of detector 18 to remove scattered excitation light. In the present embodiment, the signal information generated by detector 18 is transmitted over line 19 to signal electronics 42, which extracts and amplifies those portions of the detector's signal attributed to L1 and L2. These two analog component signals are then digitized by an analog-to-digital conversion card 46 installed in computer 44. As discussed above, this information is useful for determining the presence and concentrations of fluorescing species excited by beams L1 and L2.

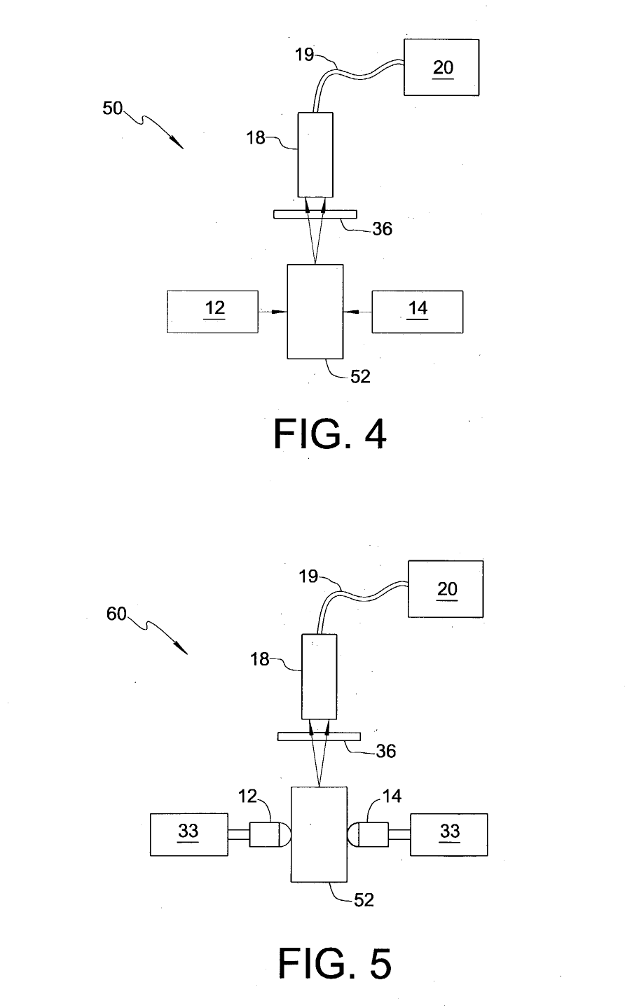

FIGS. 4 and 5 illustrate further embodiments of the present invention for analyzing a bulk quantity of sample material. In the system 50 of FIG. 4, two light sources 12 and 14 are arranged on opposite sides of a sample well 52 containing sample material in bulk. The light sources are internally modulated lasers each modulated at a fixed frequency that is different from the frequency of the other laser and not harmonics of one another. System 60 of FIG. 5 is generally similar to system 50, however light source 12 is a blue LED and light source 14 is a green LED. A function generator 33 modulates current supplied to each LED, such that the light emitted by each source is intensity modulated at a frequency that differs from the modulation frequency of the other source and are not harmonics of one another. The detection arrangements are the same for each system, and include a filter 36 for blocking excitation wavelengths, a detector 18 after the filter, and a digital storage oscilloscope 20 receiving fluorescence signal information over line 19.

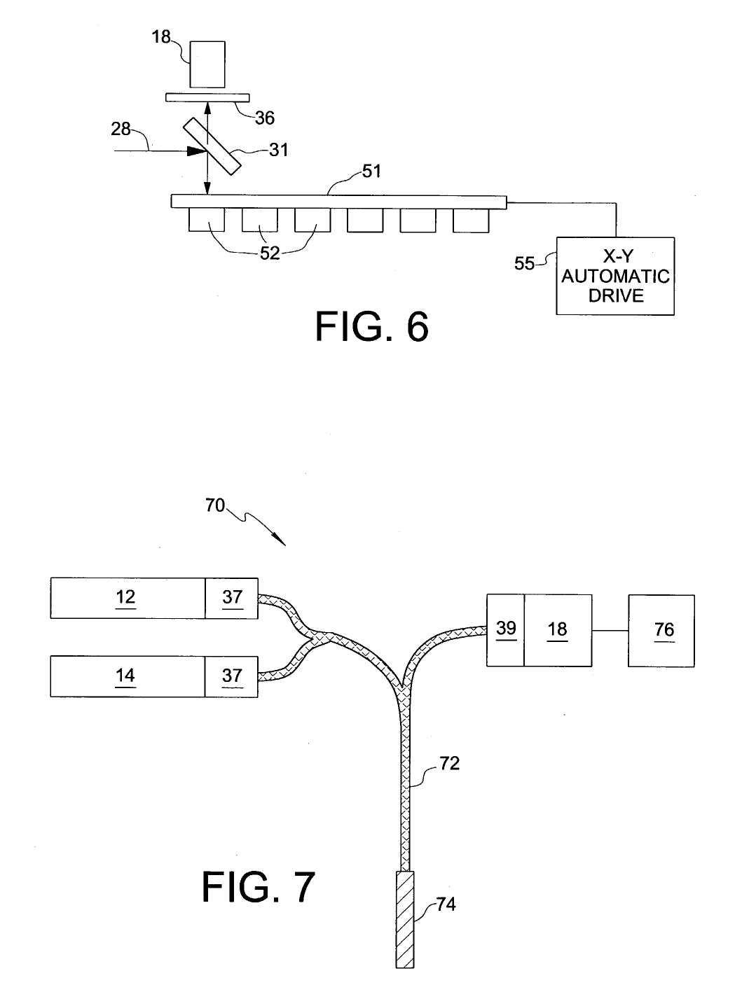

FIG. 6 shows an application wherein numerous sample materials are analyzed automatically. A well plate 51 is shown as including an array of sample wells 52 for holding sample materials. Excitation light traveling along path 28 strikes dichroic mirror 31 and is reflected to the sample material in an aligned sample well 52. Fluorescent emission light is transmitted through dichroic mirror 31 and filter 36 to detector 18. Well plate 51 can be moved automatically in a horizontal X-Y plane by an automatic drive 55 to align a different sample well 52 for analysis. Of course, dichroic mirror 31, filter 36, and detector 18 could also be moved while well plate 51 remains fixed to align another sample well 52.

Turning now to FIG. 7, a system 70 of the present invention incorporating fiber optic transmission is shown. This embodiment is primarily intended to increase sensitivity. System 70 comprises a modulated light sources 12 and 14, a bifurcated optical fiber 72, and optical means 37 associated with each light source for coupling light into optical fiber 72. Bifurcated optical fibers are commercially available, one example being the SPLIT200-UV-VIS bifurcated fiber available from Ocean Optics Inc. A distal end of the optical fiber is coated with sample material 74, such as an antibody that specifically binds an antigen. If the antigens are already fluorescently labeled, then the fluorescent labels will be excited by modulated light near the surface of fiber 72 (fluorescent dyes any distance from the surface of fiber 72 are not excited). Some of the fluorescent light is trapped in the fiber and is transmitted back through decoupling optics 39 to detector 18 connected to signal processing electronics 76. In a situation wherein the sample material is a dilute solution of fluorescently labeled antigen in water, the distal end of optical fiber 72 could be immersed in the solution to provide sufficient illumination and improve collection efficiency with respect to fluorescent light.

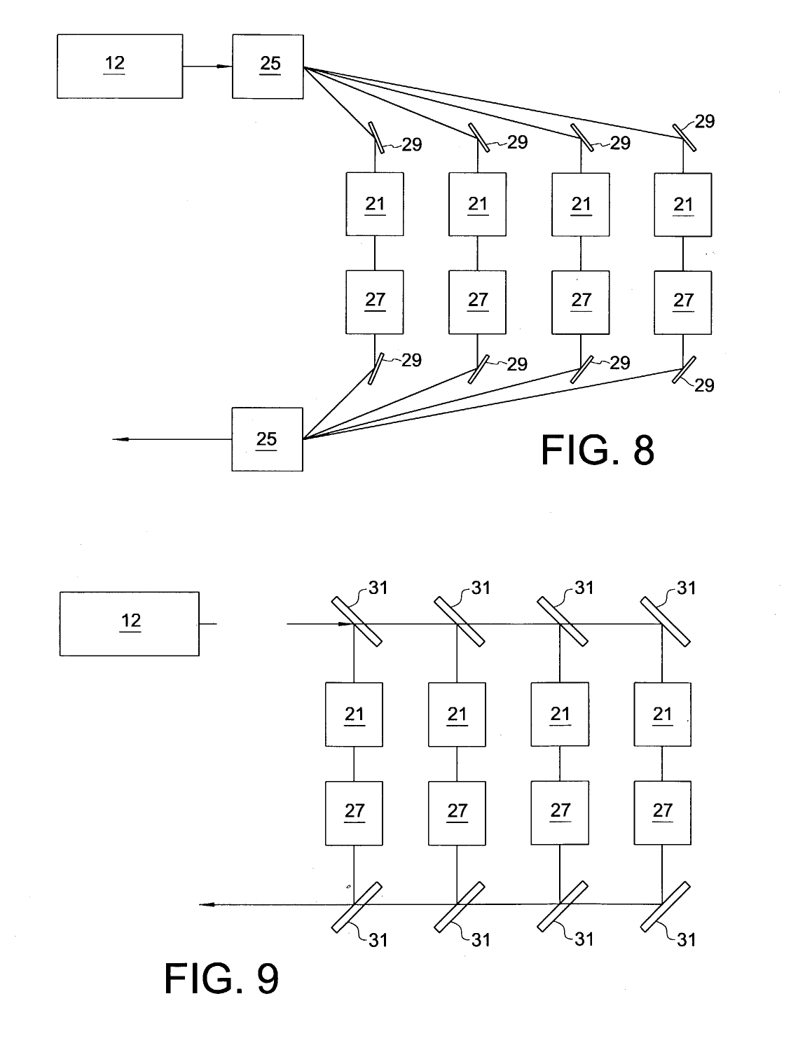

While the embodiments described above show the use of multiple light sources to generate excitation beams at different wavelengths, the present invention can also be practiced using a single light source as shown in FIGS. 8 and 9. In FIG. 8, single light source 12 is a multiline argon ion laser emitting light grouped in bands about several different strong wavelength lines. The laser light is passed through a dispersive optical element 25, such as a prism or grating, to spectrally separate the laser light into a plurality of excitation beams each at a different central wavelength. Each of the excitation beams is reflected by a mirror 29 and passed through a beam modulator 21 and an attenuator 27. The respective modulators 21 are set at different modulation frequencies. The modulated excitation beams are reflected by further mirrors 29 to pass in reverse fashion through another dispersive element 25, whereby the modulated excitation beams are recombined and directed along the same optical path. A similar system is shown in FIG. 9, however a series of dichroic mirrors 31 is used to separate out different wavelength bands from argon ion laser 12, and another series of dichroic mirrors 31 recombines and directs the modulated beams along the same optical path. Dichroic mirrors 31 could also be interference filters, fiber optic Bragg filters, or any optical element that reflects a portion of incident light and transmits a portion of incident light depending on wavelength. As will be appreciated, the single light source systems of FIG. 8 and FIG. 9 can be substituted for a multiple light source system as a means for providing a plurality of intensity-modulated excitation light beams.

It will be understood that various types of light sources, modulation techniques, detectors, and processing means can be employed to practice the present invention. By way of non-limiting example, possible light sources include internally modulated lasers such as Power Technology's IQ series lasers and LaserMax, Inc.'s LSX series lasers; single wavelength continuous wave (cw) or quasi-cw lasers; multiline argon ion lasers such as the Spectra Physics Stabilite 2017; light emitting diodes (alone or equipped with filters to narrow the emission wavelength range); and white light sources combined with selectively transmitting wavelength filters.

Modulation techniques include all possible techniques for creating an intensity modulated beam, including the use of internal modulation at the sources or external modulation downstream from the source. As used herein, “internal” modulation refers to any modulation technique that causes light to leave its source in modulated form. Examples of internal modulation techniques include direct modulation using current drive electronics such as a Wavetek Model 178-50 MHz Programmable Waveform Synthesizer, and the use of internally modulated lasers. As used herein, “external” modulation refers to any modulation technique that modulates light after it has left its source. Examples of external modulation devices include mechanical choppers, variable attenuators such as a liquid crystal devices, electro-optic modulators, acousto-optic modulators such as IntraAction's ATM200C1 modulator and Model ME driver, Mach-Zehnder interferometers, and rotating polarizers.

Various types of photosensitive detectors can be used depending upon the application. These include, without limitation, photomultiplier tubes such as the Model HC120-15 by Hamamatsu or Perkin Elmer PMTs; photodiodes and avalanche photodiodes; photoresistive detectors, charge coupled devices and CCD arrays.

Signal processing to derive the respective modulation frequencies in the fluorescence light can be accomplished using hardware and software techniques. A digital storage oscilloscope having FFT capability is readily useful for this purpose. Other possibilities include the use of lock-in amplifiers such as the EG&G Princeton Applied Research Model 5302, frequency selective analog circuits akin to those used in radios to select stations at known frequencies, and analog-to-digital conversion by a PC Card in combination with execution of Fourier transform software.

In accordance with the apparatus embodiments described above, the present invention further encompasses a method for analyzing sample material having more than one fluorescing species. Stated broadly, the method comprises the steps of providing a plurality of intensity-modulated excitation light beams each being modulated at a respective unique frequency; directing the intensity-modulated excitation light beams to interact with the sample material; detecting fluorescence emission light from the sample material to provide signal information representative of detected light intensity versus time; and extracting a plurality of component emission signals from the signal information, wherein each component emission signal corresponds to a respective one of the modulated excitation light beams. The central wavelength of each excitation light beam can be chosen depending upon the spectral properties of the fluorescent species involved for optimal signal-to-noise characteristics in the detection signal. The intensity-modulated excitation light beams can be directed along a common optical path to interact with said sample material, or they can be directed along separate optical paths to interact with said sample material. As described above in connection with the hypothetical analysis table, the method may further comprise the step of evaluating the plurality of component emission signals to determine concentration information regarding the fluorescing species in said sample material.

As will be appreciated from the foregoing description, the present invention is widely applicable in fluorescence spectroscopy. One application that is contemplated for biotechnology research is the identification of several naturally florescent proteins. A common procedure in biotechnology is to introduce foreign genetic matter into cells that codes for the production of a naturally fluorescent protein. Many such proteins exist, but generally only a few are employed at one time. Mutants of the most commonly used proteins are known to exist and often have different excitation and emission spectra. It is desirable to employ more of these proteins at one time, however a central problem to this approach is the spectral overlap of the dyes. By employing a number of excitation beams at different wavelengths and modulation frequencies, a flow cytometer operator can discriminate between dyes with similar spectroscopic properties. Information about which proteins are present in what quantities and at what time is useful for measuring one or more properties of a cell's genome. Specific applications include drug discovery, disease studies, and genetic modification studies. The present invention can also be used for chromatography and time dependent analysis of molecular processes.

From a general standpoint, the invention is suitable for analyzing gas and liquid mixtures in a flow stream. It is also suitable for measuring solid, liquid or gas mixtures in bulk. Of particular interest is the case of flowing liquids which may have dissolved or suspended fluorescing species.

What is claimed is:

1. An apparatus for analyzing sample material having more than one fluorescing species, said apparatus comprising:
means for providing a plurality of intensity-modulated excitation light beams for interaction with said sample material, each of said plurality of intensity-modulated excitation light beams being modulated at a respectively unique frequency;
a photosensitive detector receiving fluorescence light emitted by said sample material in response to interaction with said plurality of excitation light beams, said detector providing signal information representative of the intensity of received light; and
means connected to said detector for receiving and processing said signal information to extract a plurality of component signals respectively attributed to said plurality of excitation light beams.

2. The apparatus according to claim 1, wherein said means for providing a plurality of intensity-modulated excitation light beams includes a multiple wavelength light source generating a source beam and means for separating said source beam into a plurality of excitation light beams each having a respectively unique central wavelength.

3. The apparatus according to claim 2, wherein said means for providing a plurality of intensity-modulated excitation light beams further includes a plurality of beam modulators associated one with each of said plurality of excitation light beams for intensity modulating a respective excitation light beam.

4. The apparatus according to claim 2, wherein said multiple wavelength light source is a multiline laser.

5. The apparatus according to claim 2, wherein said means for separating said source beam into a plurality of excitation light beams includes an optical element for transmitting one range of wavelengths and reflecting another range of wavelengths.

6. The apparatus according to claim 5, wherein said optical element is a dichroic mirror.

7. The apparatus according to claim 5, wherein said optical element is a fiber optic Bragg grating.

8. The apparatus according to claim 2, wherein said means for separating said source beam into a plurality of excitation light beams includes a dispersive optical element.

9. The apparatus according to claim 8, wherein said dispersive optical element is a prism.

10. The apparatus according to claim 8, wherein said dispersive optical element is a diffraction grating.

11. The apparatus according to claim 2, further comprising a plurality of attenuators associated one with each of said plurality of excitation light beams.

12. The apparatus according to claim 2, further comprising means for combining said plurality of excitation light beams before said light beams interact with said sample material.

13. The apparatus according to claim 1, wherein said means for providing a plurality of intensity-modulated excitation light beams includes a plurality of light sources each generating a respective excitation light beam.

14. The apparatus according to claim 13, wherein said plurality of light sources includes a laser light source.

15. The apparatus according to claim 13, wherein at least one of said excitation light beams is modulated by internal modulation of a corresponding one of said plurality of light sources.

16. The apparatus according to claim 1, wherein said means for providing a plurality of intensity-modulated excitation light beams includes an external modulator for modulating intensity of a corresponding excitation light beam.

17. The apparatus according to claim 16, wherein said external modulator is a mechanical chopper.

18. The apparatus according to claim 16, wherein said external modulator is a liquid crystal attenuator.

19. The apparatus according to claim 16, wherein said external modulator is an electro-optic modulator.

20. The apparatus according to claim 16, wherein said external modulator is an acousto-optic modulator.

21. The apparatus according to claim 1, further comprising an illumination optical fiber for delivering at least one of said plurality of intensity-modulated excitation light beams to said sample material.

22. The apparatus according to claim 1, further comprising a detection optical fiber for delivering said light emitted by said sample material to said detector.

23. The apparatus according to claim 1, further comprising an illumination optical fiber for delivering at least one of said plurality of intensity-modulated excitation light beams to said sample material and a detection optical fiber for delivering said light emitted by said sample material to said detector.

24. The apparatus according to claim 23, wherein said illumination optical fiber and said detection optical fiber are integrated in a bifurcated optical fiber.

25. The apparatus according to claim 1, wherein said apparatus comprises more than one said photosensitive detector.

26. The apparatus according to claim 1, wherein said photosensitive detector includes a photomultiplier tube.

27. The apparatus according to claim 1, wherein said photosensitive detector includes a photodiode.

28. The apparatus according to claim 1, wherein said photosensitive detector includes a charge coupled device.

29. The apparatus according to claim 1, wherein said means for processing said signal information includes a lock-in amplifier.

30. The apparatus according to claim 1, wherein said means for processing said signal information includes an analog circuit designed to select particular frequencies.

31. The apparatus according to claim 1, wherein said means for processing said signal information includes an analog-to-digital signal converter for converting said signal information to digital form.

32. The apparatus according to claim 31, wherein said means for processing said signal information executes a Fourier transform software algorithm.

33. An apparatus for analyzing sample material having more than one fluorescing species, said apparatus comprising:
a first light source emitting a first excitation light beam;
a second light source emitting a second excitation light beam;
means for modulating the intensity of said first excitation light beam according to a first periodic function of time;
means for modulating the intensity of said second excitation light beam according to a second periodic function of time different from said first periodic function of time;
a sample container in which sample material is presented;
optical means after said first and second beam modulators for directing said first and said second excitation light beams to said sample material in said sample container for interaction with said sample material;
a photosensitive detector receiving fluorescence light emitted by said sample material in response to interaction with said first and second excitation light beams, said detector providing signal information representative of the intensity of received light;
an optical element in front of said detector for excluding excitation light from reaching said detector; and
means connected to said detector for processing said signal information to extract a first component signal corresponding to said first excitation light beam and a second component signal corresponding to said second excitation light beam.

34. The apparatus according to claim 33, wherein said first and second periodic functions of time have different frequencies.

35. The apparatus according to claim 33, wherein said sample container includes a flow cell.

36. The apparatus according to claim 33, wherein said sample container includes a sample well.

37. The apparatus according to claim 36, wherein said sample container includes a well plate having a plurality of sample wells.

38. The apparatus according to claim 37, further comprising means for selectively changing the position of said well plate relative to said optical means, whereby said first and second excitation light beams enter a chosen one of said plurality of sample wells.

39. The apparatus according to claim 33, wherein at least one of said first and second light sources is an LED which may be fitted with filters designed to reduce the emission bandwidth.

40. The apparatus according to claim 39, wherein the intensity of an excitation light beam emitted by said LED is modulated by controlling current supplied to said LED.

41. A flow cytometer comprising:
a first light source emitting a first excitation light beam;
a second light source emitting a second excitation light beam;
means for modulating the intensity of said first excitation light beam as a first periodic function of time;
means for modulating the intensity of said second excitation light beam as a second periodic function of time different from said first periodic function of time;
a flow cell through which said sample material flows;
optical means after said first and second beam modulators for directing said first and said second excitation light beams to said sample material in said sample container for interaction with said sample material; and
a photosensitive detector receiving fluorescence light emitted by said sample material in response to interaction with said first and second excitation light beams, said detector providing aggregate signal information representative of the intensity of received light, wherein said aggregate signal information includes a first component signal corresponding to said first excitation light beam and a second component signal corresponding to said second excitation light beam.

42. A method of analyzing sample material having more than one fluorescing species, said method comprising the steps of:
providing a plurality of intensity-modulated excitation light beams, each of said plurality of excitation light beams being modulated at a respective unique frequency;
directing said plurality of intensity-modulated excitation light beams to interact with said sample material;
detecting fluorescence emission light from said sample material to provide signal information representative of detected light intensity versus time; and
extracting a plurality of component emission signals from said signal information, wherein each of said plurality of component emission signals corresponds to a respective one of said plurality of excitation light beams.

43. The method according to claim 42, wherein each of said plurality of intensity-modulated excitation light beams has a central wavelength chosen to excite at least one of said species.

44. The method according to claim 42, wherein at least two of said plurality of intensity-modulated excitation light beams are directed along a common optical path to interact with said sample material.

45. The method according to claim 42, wherein at least two of said plurality of excitation light beams are directed along separate optical paths to interact with said sample material.

46. The method according to claim 42, further comprising the step of evaluating said plurality of component emission signals to determine the concentration of at least one of said fluorescing species in said sample material.
